(19) United States
(12) Patent Application Publication
(10) Pub. No.: US 2026/0136443 A1
(43) Pub. Date: May 14, 2026

(54) LED DRIVER AND OPERATING METHOD THEREOF

(71) Applicant: Delta Electronics, Inc., Taoyuan City (TW)

(72) Inventors: Ching-Ho Chou, Taoyuan City (TW); Yung-Chuan Lu, Taoyuan City (TW); Ming-Lung Hsieh, Taoyuan City (TW); Chien-Ting Lin, Taoyuan City (TW)

(21) Appl. No.: 19/247,387

(22) Filed: Jun. 24, 2025

Related U.S. Application Data
(60) Provisional application No. 63/718,323, filed on Nov. 8, 2024.

(30) Foreign Application Priority Data
May 15, 2025 (CN) 202510625058.3

(51) Int. Cl. H05B 45/50; H05B 45/325; H05B 45/355; H05B 45/3725

(52) U.S. Cl. CPC H05B 45/50; H05B 45/325; H05B 45/355; H05B 45/3725

(57) ABSTRACT

An LED driver and an operating method thereof are provided. The LED driver includes conversion circuits and a control circuit. The conversion circuits are configured to be electrically coupled to LED light sources for supplying power. The control circuit is configured to: configure the conversion circuits to generate output currents and output voltages; calculate output powers of the conversion circuits; sum up the output powers of the conversion circuits to obtain a total output power; and when it is determined that the total output power is greater than a power limit, configure at least one of the conversion circuits to reduce at least one of the output currents according to the power limit and according to at least one of the total output power and the output powers of the conversion circuits, so as to reduce the total output power to be less than or equal to the power limit.

### CROSS-REFERENCE TO RELATED APPLICATION

This application claims the benefits of U.S. Provisional Application No. 63/718,323 filed on Nov. 8, 2024 and entitled “MULTI-CHANNEL LED DRIVER WITH TOTAL POWER LIMIT PROTECTION”. This application also claims priority to China Patent Application No. 202510625058.3 filed on May 15, 2025. The entire contents of the above-mentioned patent applications are incorporated herein by reference for all purposes.

### FIELD OF THE INVENTION

The present disclosure relates to an LED (light-emitting diode) driver and an operating method thereof, and more particularly to an LED driver and an operating method thereof with a total power limit protection function.

### BACKGROUND OF THE INVENTION

In LED lighting applications, the LED driver is usually adopted to provide appropriate voltage and current for allowing the LED light source to operate stably and efficiently. The LED driver may include a plurality of voltage converters to satisfy power requirements for different LED light sources. The plurality of voltage converters are respectively electrically coupled to a pre-stage PFC (power factor correction) circuit to receive power that has been processed with power factor correction by the PFC circuit. In addition, the plurality of voltage converters are also electrically coupled to a plurality of LED light sources respectively to supply power to different LED light sources respectively.

Generally, each voltage converter itself has an overpower protection function to automatically adjust or shut down when the output power exceeds the safe range, thereby avoiding damage caused by overload. However, from the perspective of the overall system, the PFC circuit needs to bear the power supply of the entire system, and the heat dissipation capability of the PFC circuit and the LED luminaire also affects the stability and operational performance of the overall system. Since the voltage converters do not operate at maximum power simultaneously, designing by directly summing up the maximum powers of all voltage converters would result in a product with an excessively large volume and low power density, which may fail to meet the specific product specification. If the sum of the maximum powers of all voltage converters is not taken into consideration, the situation that the total output power and generated heat of the LED driver exceed the tolerable range of the overall system may occur, which would affect the operational stability and lifespan of the LED driver. Additionally, in applications such as plant lighting, the LED driver supplies power respectively to different LED light sources such as red light, far-infrared, blue light, and white light. Hence, the LED driver needs to flexibly adjust the power of each LED light source to meet various lighting needs for different purposes.

Therefore, there is a need of providing an LED driver and an operating method thereof in order to overcome the drawbacks of the conventional technologies.

### SUMMARY OF THE INVENTION

The present disclosure provides an LED driver and an operating method thereof in order to overcome the drawbacks of the conventional technologies.

In accordance with an aspect of the present disclosure, an LED driver is provided. The LED driver is configured to drive a plurality of LED light sources according to an input voltage and includes a plurality of conversion circuits and a control circuit. A plurality of output terminals of the plurality of conversion circuits are configured to be electrically coupled to the plurality of LED light sources respectively to supply power to the plurality of LED light sources. The plurality of conversion circuits form a first-stage circuit and a second-stage circuit. The first-stage circuit includes an input terminal configured to receive the input voltage, and the second-stage circuit includes an input terminal electrically coupled to an output terminal of the first-stage circuit. The control circuit is electrically coupled to the conversion circuits for configuring the conversion circuits to generate a plurality of output currents and a plurality of output voltages respectively at the output terminals of the conversion circuits. The control circuit is configured to calculate a plurality of output powers of the conversion circuits according to the output currents and the output voltages of the conversion circuits. The control circuit is configured to sum up the output powers of the conversion circuits to obtain a total output power. When the control circuit determines that the total output power is greater than a power limit, the control circuit configures at least one of the conversion circuits to reduce at least one of the output currents according to the power limit and according to at least one of the total output power and the output powers of the conversion circuits, so as to reduce the total output power to be less than or equal to the power limit.

In accordance with another aspect of the present disclosure, an operating method of an LED driver is provided. The LED driver is configured to drive a plurality of LED light sources according to an input voltage and includes a plurality of conversion circuits and a control circuit. A plurality of output terminals of the plurality of conversion circuits are configured to be electrically coupled to the plurality of LED light sources respectively to supply power to the plurality of LED light sources. The plurality of conversion circuits form a first-stage circuit and a second-stage circuit. The first-stage circuit includes an input terminal configured to receive the input voltage, and the second-stage circuit includes an input terminal electrically coupled to an output terminal of the first-stage circuit. The control circuit is electrically coupled to the plurality of conversion circuits. The operating method includes steps of: (a) configuring the conversion circuits to generate a plurality of output currents and a plurality of output voltages respectively at the output terminals of the conversion circuits by the control circuit; (b) calculating a plurality of output powers of the conversion circuits according to the output currents and the output voltages of the conversion circuits by the control circuit; (c) summing up the output powers of the conversion circuits to obtain a total output power by the control circuit; and (d) when the control circuit determines that the total output power is greater than a power limit, configuring at least one of the conversion circuits to reduce at least one of the output currents according to the power limit and according to at least one of the total output power and the output powers of the conversion circuits by the control circuit, so as to reduce the total output power to be less than or equal to the power limit.

In the present disclosure, when the total output power is too high, the output current of each conversion circuit is reduced to limit the total output power within the tolerable range of the overall system, thereby improving the operational stability and lifespan of the LED driver.

### BRIEF DESCRIPTION OF THE DRAWINGS

FIG. 1 is a schematic block diagram illustrating an LED driver according to an embodiment of the present disclosure;

FIG. 2 is a schematic block diagram illustrating the control circuit of FIG. 1; and

FIG. 3 is a schematic flow chart illustrating an operating method of an LED driver according to an embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

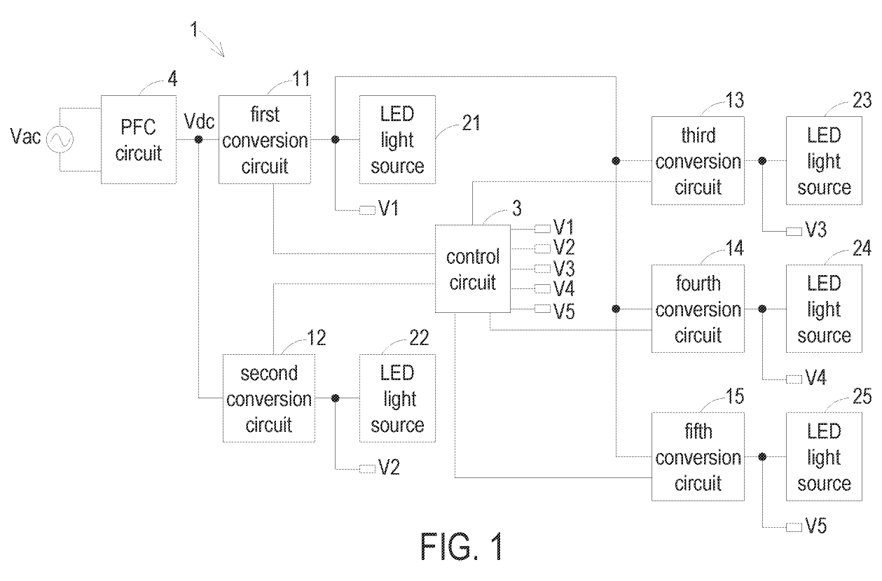

FIG. 1 is a schematic block diagram illustrating an LED driver according to an embodiment of the present disclosure. As shown in FIG. 1, the LED driver 1 is configured to drive a plurality of LED light sources (five LED light sources 21, 22, 23, 24 and 25 are exemplified in the figure). In the embodiment of FIG. 1, the LED driver 1 includes a PFC circuit 4, a control circuit 3, and a first-stage circuit and a second-stage circuit formed by a plurality of conversion circuits. The first-stage circuit includes one or more conversion circuits (two conversion circuits are exemplified in the figure, namely a first conversion circuit 11 and a second conversion circuit 12), and the second-stage circuit includes one or more conversion circuits (three conversion circuits are exemplified in the figure, namely a third conversion circuit 13, a fourth conversion circuit 14, and a fifth conversion circuit 15). For the sake of brevity, other components of the LED driver 1 are not depicted in FIG. 1. In this embodiment, the LED driver 1 is divided into the PFC circuit 4, the first conversion circuit 11, the second conversion circuit 12, the third conversion circuit 13, the fourth conversion circuit 14, the fifth conversion circuit 15, and the control circuit 3 for clearly describing the operation of the LED driver 1. The PFC circuit 4, the first conversion circuit 11, the second conversion circuit 12, the third conversion circuit 13, the fourth conversion circuit 14, the fifth conversion circuit 15, and the control circuit 3 may be implemented by suitable components respectively, or may be integrated into or separately implemented by one or more components. In another embodiment, the functions of the PFC circuit 4, the first conversion circuit 11, the second conversion circuit 12, the third conversion circuit 13, the fourth conversion circuit 14, the fifth conversion circuit 15, and the control circuit 3 may be performed by the same circuit formed by discrete components and/or integrated circuit components.

The PFC circuit 4 is configured to receive an AC voltage Vac and correspondingly generate a DC voltage Vdc according to the AC voltage Vac. The PFC circuit 4 may adopt any suitable power conversion architecture to implement power factor correction and provide the required DC voltage Vdc, for example but not limited to a passive PFC circuit, an active boost PFC circuit or a bridgeless PFC circuit.

In the first-stage circuit, input terminals of the first conversion circuit 11 and the second conversion circuit 12 are electrically coupled in parallel to each other and are both electrically coupled to the PFC circuit 4 to receive the DC voltage Vdc. Further, an output terminal of each conversion circuit in the first-stage circuit is electrically coupled to a corresponding LED light source and supplies power to it. In specific, in this embodiment, the output terminal of the first conversion circuit 11 is electrically coupled to the LED light source 21, and the first conversion circuit 11 generates an output voltage V1 according to the DC voltage Vdc to supply power to the LED light source 21. The output terminal of the second conversion circuit 12 is electrically coupled to the LED light source 22, and the second conversion circuit 12 generates an output voltage V2 according to the DC voltage Vdc to supply power to the LED light source 22. The first conversion circuit 11 and the second conversion circuit 12 may adopt suitable power conversion architectures to provide the power required by the LED light sources 21 and 22, such as buck conversion circuits, inverse buck conversion circuits, or buck-boost conversion circuits. In addition, depending on whether buck conversion circuits or inverse buck conversion circuits are adopted, the positive or negative output terminals of all conversion circuits in the first-stage circuit may be electrically coupled to each other accordingly.

The input terminal of each conversion circuit in the second-stage circuit is electrically coupled to the output terminal of a corresponding conversion circuit in the first-stage circuit to receive power, and the output terminal of each conversion circuit in the second-stage circuit is electrically coupled to a corresponding LED light source and supplies power to it. The plurality of conversion circuits in the second-stage circuit may be electrically coupled to the same conversion circuit in the first-stage circuit, or may be electrically coupled to plural different conversion circuits in the first-stage circuit. In this embodiment, the input terminals of the third conversion circuit 13, the fourth conversion circuit 14, and the fifth conversion circuit 15 are all electrically coupled to the output terminal of first conversion circuit 11 to receive the output voltage V1 of the first conversion circuit 11. The output terminal of the third conversion circuit 13 is electrically coupled to the LED light source 23, and the third conversion circuit 13 generates an output voltage V3 according to the output voltage V1 to supply power to the LED light source 23. The output terminal of the fourth conversion circuit 14 is electrically coupled to the LED light source 24, and the fourth conversion circuit 14 generates an output voltage V4 according to the output voltage V1 to supply power to the LED light source 24. The output terminal of the fifth conversion circuit 15 is electrically coupled to the LED light source 25, and the fifth conversion circuit 15 generates an output voltage V5 according to the output voltage V1 to supply power to the LED light source 25. The third conversion circuit 13, the fourth conversion circuit 14, and the fifth conversion circuit 15 may adopt suitable power conversion architectures to provide the power required by the LED light sources 23, 24 and 25, such as buck conversion circuits, inverse buck conversion circuits, or buck-boost conversion circuits. In addition, depending on whether buck conversion circuits or inverse buck conversion circuits are adopted, the positive or negative output terminals of all conversion circuits in the second-stage circuit may be electrically coupled to each other accordingly.

In this embodiment, the DC voltage Vdc is greater than the output voltage V1 in the first-stage circuit, and the output voltage V1 is greater than the output voltages V3, V4, and V5 in the second-stage circuit. The first conversion circuit 11 in the first-stage circuit steps down the DC voltage Vdc to a lower output voltage V1, and then provides the output voltage V1 to the third conversion circuit 13, the fourth conversion circuit 14, and the fifth conversion circuit 15 in the second-stage circuit. The third conversion circuit 13, the fourth conversion circuit 14, and the fifth conversion circuit 15 in the second-stage circuit convert the output voltage V1 into lower output voltages V3, V4, and V5 respectively. The output voltages V3, V4, and V5 may be configured as the same voltage value or different voltage values. In this embodiment, through a multi-stage step-down conversion operation, the conversion circuits in both the first-stage circuit and the second-stage circuits are allowed to operate in ranges with higher conversion efficiency. In another embodiment, it may be configured that the first conversion circuit 11 and the second conversion circuit 12 in the first-stage circuit respectively provide the output voltages V1 and V2 to the third conversion circuit 13, the fourth conversion circuit 14, and the fifth conversion circuit 15 in the second-stage circuit, and the third conversion circuit 13, the fourth conversion circuit 14, and the fifth conversion circuit 15 convert the output voltages V1 and V2 into lower output voltages V3, V4, and V5.

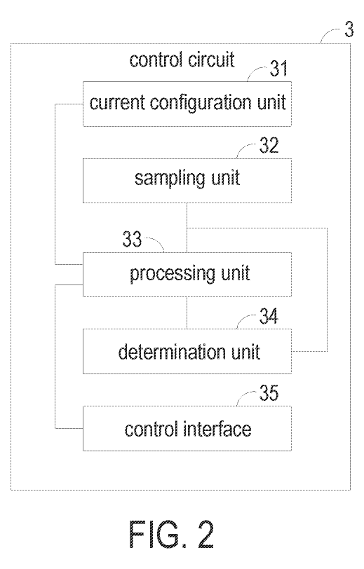

The control circuit 3 is electrically coupled to the first-stage circuit and the second-stage circuit. Namely, in this embodiment, the control circuit 3 is electrically coupled to the first conversion circuit 11, the second conversion circuit 12, the third conversion circuit 13, the fourth conversion circuit 14, and the fifth conversion circuit 15. The control circuit 3 may include components such as logic circuits and is configured to control the operation of each conversion circuit. For example, FIG. 2 is a schematic block diagram illustrating the control circuit 3 of FIG. 1 according to an embodiment of the present disclosure. As shown in FIG. 2, the control circuit 3 includes a current configuration unit 31, a sampling unit 32, a processing unit 33, a determination unit 34, and a control interface 35. For the sake of brevity, other components of the control circuit 3 are not depicted in the embodiment of FIG. 2. In other embodiments, the components of the control circuit 3 may be added or reduced according to different design considerations. In this embodiment, the control circuit 3 is divided into the current configuration unit 31, the sampling unit 32, the processing unit 33, the determination unit 34, and the control interface 35 for clearly describing the control manner of the control circuit 3 for the operation of each conversion circuit. These components of the control circuit 3 may be implemented by suitable circuit components respectively, or may be integrated into or separately implemented by one or more circuit components. In another embodiment, the functions of the current configuration unit 31, the sampling unit 32, the processing unit 33, the determination unit 34, and the control interface 35 may be performed by the same circuit formed by discrete components and/or integrated circuit components., or may be implemented by using software and/or firmware in conjunction with hardware.

Please refer to FIG. 1 and FIG. 2. The current configuration unit 31 of the control circuit 3 may configure each conversion circuit to generate the required output current. In an embodiment, the control circuit 3 may receive a command through the control interface 35 (e.g., parameters such as ON/OFF status or brightness for each LED light source input by a user), and the current configuration unit 31 configures each conversion circuit to generate the required output current according to the command. For example, the control interface 35 may be implemented by a graphical user interface or a digital addressable lighting interface (DALI).

The sampling unit 32 of the control circuit 3 may sample the output voltage and/or the output current generated by the conversion circuit. Since the output current generated by the conversion circuit is configured by the current configuration unit 31, the processing unit 33 of the control circuit 3 may calculate the output power of the conversion circuit according to the sampled output current and the sampled output voltage, or may calculate the output power of the conversion circuit according to the configured output current and the sampled output voltage. For example, the current configuration unit 31 configures the first conversion circuit 11 to generate the output current I1 at its output terminal, the sampling unit 32 samples the output voltage V1 at the output terminal of the first conversion circuit 11, and the processing unit 33 multiplies the configured output current I1 and the sampled output voltage V1 of the first conversion circuit 11 to calculate the output power of the first conversion circuit 11. In another embodiment, the sampling unit 32 samples the output voltage V1 and the output current I1 at the output terminal of the first conversion circuit 11, and the processing unit 33 multiplies the sampled output current I1 and the sampled output voltage V1 of the first conversion circuit 11 to calculate the output power of the first conversion circuit 11. Similarly, the control circuit 3 may obtain the output powers of the second conversion circuit 12, the third conversion circuit 13, the fourth conversion circuit 14, and the fifth conversion circuit 15 in the same manner. The processing unit 33 sums up the output powers of the conversion circuits to obtain the total output power of the LED driver 1 (the processing unit 33 may sum up the output powers of all the conversion circuits, or may only sum up the output powers of the conversion circuits that are currently operating). The determination unit 34 compares the total output power with a power limit, where the power limit may be set to a value less than the sum of the rated powers of all the conversion circuits, a value less than the sum of the trigger powers of overpower protection of all the conversion circuits, or other suitable value (the specific value of the power limit may be set according to actual requirements, such as according to the load capacity of the PFC circuit 4 and the heat dissipation capability of the LED light sources). When the determination unit 34 determines that the total output power is greater than the power limit, the control circuit 3 performs an adjustment mode. In the adjustment mode, the current configuration unit 31 of the control circuit 3 configures each conversion circuit to adjust its output current according to the power limit and according to at least one of the total output power and the output powers of the conversion circuits (e.g., at least one of the output powers of the five conversion circuits (11–15) and their summed total output power). Thereby, the output power of each conversion circuit is adjusted, and the total output power is reduced to be less than or equal to the power limit. In an embodiment, the current configuration unit 31 of the control circuit 3 determines an adjustment ratio according to the difference between the total output power and the power limit for configuring the conversion circuits to adjust their output current with the same adjustment ratio or different adjustment ratios. For instance, according to the difference between the total output power and the power limit, the control circuit 3 adopts the same adjustment ratio to configure each conversion circuit to reduce its output current. For example, under the circumstance that the total output power is 2000W and the power limit is 1800W, the difference between the total output power and the power limit is 200W, and the control circuit 3 configures each conversion circuit to reduce its output current by 10% (= 200W/2000W) or a greater percentage according to the difference. Thereby, the total output power is reduced to be less than or equal to the power limit. In another embodiment, under the circumstance that the total output power is 2000W and the power limit is 1800W, according to the difference between the total output power and the power limit, the control circuit 3 may configure each conversion circuit with a different reduction ratio for its output current such that the total output power of the LED driver 1 is reduced to 1800W or a lower power value. For example, according to the total output power and the output powers of the conversion circuits, the control circuit 3 configures the conversion circuit with higher output power to reduce its output current by a larger ratio, and configures the conversion circuit with lower output power to reduce its output current by a smaller ratio. In another embodiment, according to the total output power and the output powers of the conversion circuits, the control circuit 3 configures the conversion circuit with higher output power to reduce its output current by a smaller ratio, and configures the conversion circuit with lower output power to reduce its output current by a larger ratio.

From the above, the LED driver 1 of the present disclosure can limit the total output power within the tolerable range of the overall system, thereby realizing the total power limit protection function to improve the operational stability and lifespan of the LED driver.

In the embodiment shown in FIG. 1, the plurality of conversion circuits of the LED driver 1 form the circuit with two stages. In another embodiment, the plurality of conversion circuits of the LED driver may form the circuit with more stages, in which, except for the conversion circuits in the first-stage circuit, the input terminal of the conversion circuit in any stage is electrically coupled to the output terminal of the corresponding conversion circuit in the preceding stage. In addition, in further another embodiment, the plurality of conversion circuits of the LED driver may form a single-stage circuit, which means that the input terminals of all the conversion circuits are electrically coupled in parallel to each other and receive the same input voltage. By configuring LED driver 1 with a suitable circuit architecture, the conversion circuits can operate in the desired operating mode, thereby improving the conversion efficiency.

Additionally, the components of LED driver 1 may be added or reduced according to different design considerations. For example, in the embodiment shown in FIG. 1, the LED driver 1 includes the PFC circuit 4. In another embodiment, when the LED driver is electrically coupled to a DC input power source, the LED driver may not include the PFC circuit 4.

The control circuit 3 may transmit control signals in a pulse-width modulation (PWM) format, a pulse-frequency modulation (PFM) format, or other suitable formats to respectively configure the output current of each conversion circuit. In an embodiment, the control circuit 3 provides the control signal in PWM format to each conversion circuit for generating the required output current accordingly. The control circuit 3 sets a configured current for the first conversion circuit 11 and provides the control signal in PWM format to the first conversion circuit 11 according to the configured current. Further, the control circuit 3 sets the duty cycle of the control signal such that the first conversion circuit 11 operates according to the control signal to generate the output current equal to the configured current. Similarly, the control circuit 3 provides the control signals in PWM format to the second conversion circuit 12, the third conversion circuit 13, the fourth conversion circuit 14, and the fifth conversion circuit 15 respectively, thereby controlling the second conversion circuit 12, the third conversion circuit 13, the fourth conversion circuit 14, and the fifth conversion circuit 15 to generate output currents equal to their respective configured currents.

In an embodiment, the duty cycle of the control signal in PWM format provided by the control circuit 3 is positively correlated with the magnitude of the output current of the corresponding conversion circuit. Therefore, in the adjustment mode, the control circuit 3 may reduce the output current of the corresponding conversion circuit by decreasing the duty cycle of the control signal in PWM format.

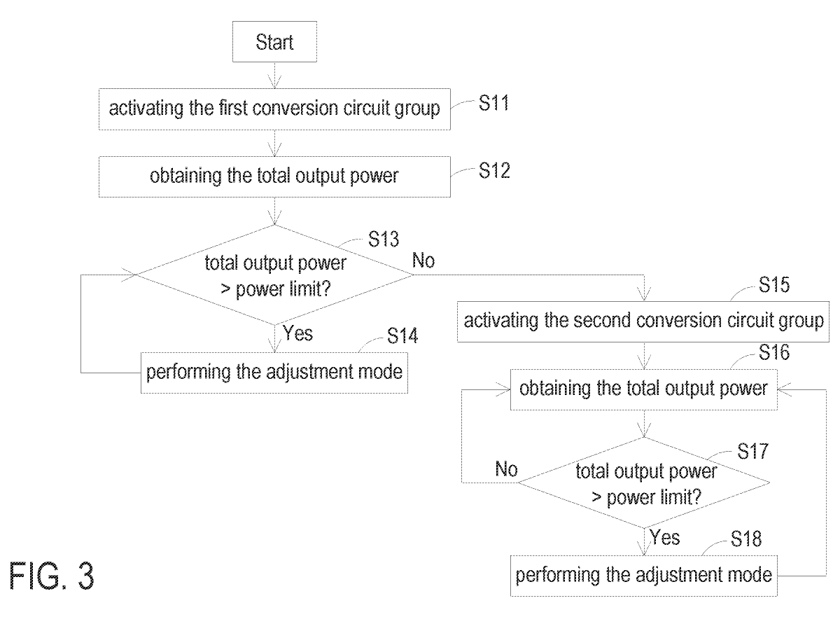

Please refer to FIG. 3 in conjunction with FIG. 1. FIG. 3 is a schematic flow chart illustrating an operating method of an LED driver according to an embodiment of the present disclosure, and this operating method is applicable to the LED driver 1 shown in FIG. 1. Taking the plurality of conversion circuits of the LED driver 1 forming a first conversion circuit group and a second conversion circuit group as an example, the first conversion circuit group includes the first conversion circuit 11, the second conversion circuit 12 and the third conversion circuit 13 with higher power, and the second conversion circuit group includes the fourth conversion circuit 14 and the fifth conversion circuit 15 with lower power. As shown in FIGS. 1 and 3, in step S11, the control circuit 3 activates the first conversion circuit group. In step S12, the control circuit 3 obtains the total output power of the LED driver 1 (which is the sum of the output powers of the conversion circuits that are operating in the first conversion circuit group at this point). In step S13, the control circuit 3 determines whether the total output power of LED driver 1 is greater than the power limit.

If the determination result of the step S13 is positive (i.e., the total output power of LED driver 1 is greater than the power limit), step S14 is performed to let the control circuit 3 perform the adjustment mode. In the adjustment mode, since the second conversion circuit group has not yet activated, the control circuit 3 configures the conversion circuits in the first conversion circuit group to reduce their output current according to the power limit and according to at least one of the total output power and the output powers of the conversion circuits in the first conversion circuit group. Thereby, the total output power of the LED driver 1 is reduced to be less than or equal to the power limit.

After performing the step S14, the step S13 is performed again to determine whether the total output power of LED driver 1 is greater than the power limit. If the determination result of the step S13 is negative (i.e., the total output power of LED driver 1 is less than or equal to the power limit), the step S15 is performed to let the control circuit 3 activate the second conversion circuit group.

In another embodiment, the LED driver is configured such that the maximum output power of the first conversion circuit group is less than the power limit. In this case, the steps S13 and S14 may be omitted. After the first conversion circuit group is activated in the step S11, the step S15 is performed to activate the second conversion circuit group.

In step S16, the control circuit 3 obtains the total output power of LED driver 1 (which is the sum of the output powers of all conversion circuits of the first and second conversion circuit groups at this point). In step S17, the control circuit 3 determines whether the total output power is greater than the power limit. If the determination result of the step S17 is positive, the step S18 is performed to let the control circuit 3 perform the adjustment mode to reduce the total output power by decreasing the output currents of the conversion circuits. After performing the step S18, the step S16 is performed again. Additionally, if the determination result of the step S17 is negative, the step S16 is performed again. In subsequent operations, the control circuit 3 may continuously perform the steps S16 to S18 to monitor the total output power of LED driver 1 and adjust the output current of each conversion circuit correspondingly, thereby ensuring that the total output power of the LED driver 1 remains less than or equal to the power limit.

In the adjustment mode of steps S14 and S18, according to the power limit and at least one of the total output power and the output powers of the conversion circuits, the control circuit 3 may configure only some of the conversion circuits to reduce their output currents while configuring specific conversion circuits to maintain or increase their output currents. For example, in the adjustment mode of step S18, when the total output power of the LED driver 1 is close to the power limit and it is desired to increase the output power of the fourth conversion circuit 14, the control circuit 3 may gradually increase the output current of the fourth conversion circuit 14, and perform the steps S16 to S18 to configure the other conversion circuits which are operating to decrease their output currents. Thereby, it can also be ensured that the total output power of the LED driver 1 is less than or equal to the power limit.

In the embodiment of FIG. 3, the conversion circuit groups may be activated in batches. Further, when each conversion circuit group is activated, it is confirmed whether the sum of the output powers of the conversion circuits in the activated conversion circuit group is greater than the power limit. The next batch of conversion circuit group is only activated after confirming that the sum is less than or equal to the power limit. Consequently, the components can be prevented from being damaged or failing due to high current or voltage stress during startup, and the total power limit protection function during the startup process can be realized. Furthermore, after the conversion circuits of all the conversion circuit groups have been activated, the total output power is still continuously monitored to determine whether the total output power is greater than the power limit. Accordingly, when the total output power exceeds the power limit, the total output power is reduced in real time by decreasing the output current of each conversion circuit, thereby continuously realizing the total power limit protection function during operation.

In addition, the classification logic for classifying the plurality of conversion circuits into different conversion circuit groups is not limited and can be determined according to actual requirements. For example, in an embodiment, each conversion circuit group is formed by the conversion circuits in the same stage circuit. In particular, the first conversion circuit group includes the first conversion circuit 11 and the second conversion circuit 12 in the first-stage circuit, and the second conversion circuit group includes the third conversion circuit 13, the fourth conversion circuit 14, and the fifth conversion circuit 15 in the second-stage circuit. In another embodiment, the sum of the rated powers of the conversion circuits in each conversion circuit group is less than or equal to the power limit. Assuming that the power limit is 1800W and the rated powers of the first conversion circuit 11, the second conversion circuit 12, the third conversion circuit 13, the fourth conversion circuit 14, and the fifth conversion circuit 15 are 700W, 700W, 400W, 200W and 200W respectively, the first conversion circuit group may include the first conversion circuit 11, the second conversion circuit 12 and the third conversion circuit 13, and the second conversion circuit group may include the fourth conversion circuit 14 and the fifth conversion circuit 15. Therefore, if the control circuit 3 only activates one of the first and second conversion circuit groups, the total output power of the LED driver would not exceed the power limit.

Moreover, it is noted that the specific number of the conversion circuit groups is not limited and may be determined according to actual requirements. When there are three or more conversion circuit groups, the conversion circuit groups may be activated in batches according to the same principle as the operation method shown in FIG. 3, and thus the detailed descriptions thereof are omitted herein.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An LED driver, configured to drive a plurality of LED light sources according to an input voltage, and comprising:
a plurality of conversion circuits, wherein a plurality of output terminals of the plurality of conversion circuits are configured to be electrically coupled to the plurality of LED light sources respectively to supply power to the plurality of LED light sources, the plurality of conversion circuits form a first-stage circuit and a second-stage circuit, the first-stage circuit comprises an input terminal configured to receive the input voltage, and the second-stage circuit comprises an input terminal electrically coupled to an output terminal of the first-stage circuit; and
a control circuit, electrically coupled to the conversion circuits for configuring the conversion circuits to generate a plurality of output currents and a plurality of output voltages respectively at the output terminals of the conversion circuits;
wherein the control circuit is configured to calculate a plurality of output powers of the conversion circuits according to the output currents and the output voltages of the conversion circuits;
the control circuit is configured to sum up the output powers of the conversion circuits to obtain a total output power; and
when the control circuit determines that the total output power is greater than a power limit, the control circuit configures at least one of the conversion circuits to reduce at least one of the output currents according to the power limit and according to at least one of the total output power and the output powers of the conversion circuits, so as to reduce the total output power to be less than or equal to the power limit.

2. The LED driver according to claim 1, wherein the control circuit is configured to determine an adjustment ratio according to a difference between the total output power and the power limit for configuring at least one of the conversion circuits to reduce at least one of the output currents according to the adjustment ratio.

3. The LED driver according to claim 1, wherein the control circuit is configured to determine a plurality of adjustment ratios according to the power limit and according to at least one of the total output power and the output powers of the conversion circuits for configuring each of the conversion circuits to reduce the output current by one of the adjustment ratios.

4. The LED driver according to claim 1, wherein the control circuit is configured to determine a plurality of adjustment ratios according to the power limit and according to at least one of the total output power and the output powers of the conversion circuits for configuring part of the conversion circuits to reduce the output current by one of the adjustment ratios.

5. The LED driver according to claim 1, wherein the plurality of conversion circuits form a first conversion circuit group and a second conversion circuit group;
the control circuit is configured to activate the first conversion circuit group and compare the total output power with the power limit;
when the control circuit determines that the total output power is greater than the power limit, the control circuit configures at least one of the conversion circuits in the first conversion circuit group to reduce at least one of the output currents according to the power limit and according to at least one of the total output power and the output powers of the conversion circuits in the first conversion circuit group, so as to reduce the total output power to be less than or equal to the power limit;
when the control circuit determines that the total output power is less than or equal to the power limit, the control circuit activates the second conversion circuit group and compare the total output power with the power limit; and
when the control circuit determines that the total output power is greater than the power limit, the control circuit configures at least one of the conversion circuits to reduce at least one of the output currents according to the power limit and according to at least one of the total output power and the output powers of the conversion circuits, so as to reduce the total output power to be less than or equal to the power limit.

6. An operating method of an LED driver, wherein the LED driver is configured to drive a plurality of LED light sources according to an input voltage and comprises a plurality of conversion circuits and a control circuit, a plurality of output terminals of the plurality of conversion circuits are configured to be electrically coupled to the plurality of LED light sources respectively to supply power to the plurality of LED light sources, the plurality of conversion circuits form a first-stage circuit and a second-stage circuit, the first-stage circuit comprises an input terminal configured to receive the input voltage, and the second-stage circuit comprises an input terminal electrically coupled to an output terminal of the first-stage circuit, the control circuit is electrically coupled to the plurality of conversion circuits, and the operating method comprises steps of:
(a) configuring the conversion circuits to generate a plurality of output currents and a plurality of output voltages respectively at the output terminals of the conversion circuits by the control circuit;
(b) calculating a plurality of output powers of the conversion circuits according to the output currents and the output voltages of the conversion circuits by the control circuit;
(c) summing up the output powers of the conversion circuits to obtain a total output power by the control circuit; and
(d) when the control circuit determines that the total output power is greater than a power limit, configuring at least one of the conversion circuits to reduce at least one of the output currents according to the power limit and according to at least one of the total output power and the output powers of the conversion circuits by the control circuit, so as to reduce the total output power to be less than or equal to the power limit.

7. The operating method according to claim 6, wherein in the step (d), the control circuit determines an adjustment ratio according to a difference between the total output power and the power limit for configuring at least one of the conversion circuits to reduce at least one of the output currents according to the adjustment ratio.

8. The operating method according to claim 6, wherein in the step (d), the control circuit determines a plurality of adjustment ratios according to the power limit and according to at least one of the total output power and the plurality of output powers of the plurality of conversion circuits for configuring each of the plurality of conversion circuits to reduce the output current by one of the plurality of adjustment ratios.

9. The operating method according to claim 6, wherein in the step (d), the control circuit determines a plurality of adjustment ratios according to the power limit and according to at least one of the total output power and the plurality of output powers of the plurality of conversion circuits for configuring part of the plurality of conversion circuits to reduce the output current by one of the plurality of adjustment ratios.

10. The operating method according to claim 6, wherein the plurality of conversion circuits form a first conversion circuit group and a second conversion circuit group, and the operating method further comprises:
activating the first conversion circuit group and comparing the total output power with the power limit by the control circuit;
when the control circuit determines that the total output power is greater than the power limit, configuring at least one of the conversion circuits in the first conversion circuit group to reduce at least one of the output currents according to the power limit and according to at least one of the total output power and the output powers of the conversion circuits in the first conversion circuit group by the control circuit, so as to reduce the total output power to be less than or equal to the power limit;
when the control circuit determines that the total output power is less than or equal to the power limit, activating the second conversion circuit group and comparing the total output power with the power limit by the control circuit; and
when the control circuit determines that the total output power is greater than the power limit, configuring at least one of the conversion circuits to reduce at least one of the output currents according to the power limit and according to at least one of the total output power and the output powers of the conversion circuits by the control circuit, so as to reduce the total output power to be less than or equal to the power limit.
